(19) United States
(12) Patent Application Publication
(10) Pub. No.: US 2011/0320374 A1
(43) Pub. Date: Dec. 29, 2011

(54) METHODS AND COLLECTIVE REASONING FRAMEWORK FOR COMPLEX DECISION MAKING

(76) Inventors: Emily Yanxin Wang, Renton, WA (US); Neel D. Sheth, Cambridge, MA (US)

(21) Appl. No.: 12/825,110

(22) Filed: Jun. 28, 2010

(51) Int. Cl. G06Q 99/00

(52) U.S. Cl. 705/319

(57) ABSTRACT

A computer-based method for building a framework to be utilized in collaborative decision making related to a topic of interest is provided. The method includes defining a collaborative framework space in a memory to store data relating to the topic of interest, selecting individuals within a community of interest to be involved in the collaborative decision regarding the topic of interest, using at least one computer-based collaboration methodology to allow discussion and deliberation on the topic of interest within the community of interest, generating an argumentation tree based on the discussion and deliberation, iteratively refining the argumentation tree based on the discussion and deliberation within the community of interest until the argumentation tree describes a consensus decision related to the topic of interest.

### BACKGROUND

The field of the disclosure relates generally to decision making environments, and more specifically, to a collective reasoning framework for complex decision making and methods that are associated therewith.

In an enterprise environment, many decisions have to be made collaboratively. In addition, various consensuses need to be formed on a host of different issues. With online collaboration playing a more important role in business, there are many collaboration tools available which purport to support decision makers, analysts, and the like. Some of the available tools which are used to share information include those tools that are colloquially referred to as chats, wikis, discussion boards, and blogs to name a few. However, these collaboration tools have a very limited capability to support consensus formation and collective reasoning processes even though such tools function well in the support of information and idea sharing.

In regard to certain of the existing solutions, the use of online discussion boards allows participants to propose ideas, share pros and cons, and list evidences. However, the posts in online discussion boards are in time order and therefore are not structured for decision making and collective reasoning.

Issue Based Systems (IBSs) and idea mapping tools, such as Deliberatorium by MIT, support organization of group ideas, evidences, and arguments into an argumentation map, but automatic reasoning on evidences is not enabled, and therefore greatly reduce the usefulness of such tools. In addition, most IBSs do not handle large scale collective reasoning well.

Decision market systems and electronic voting systems are other tools that harness collective intelligence for making decisions. However, such systems involve a lot of uncertainty in regard to the inputs and therefore are not viable for reliable collective reasoning related to complex decision making.

### BRIEF DESCRIPTION

In one aspect, a computer-based method for building a framework to be utilized in collaborative decision making related to a topic of interest is provided. The method includes defining a collaborative framework space in a memory to store data relating to the topic of interest, selecting individuals within a community of interest to be involved in the collaborative decision regarding the topic of interest, using at least one computer-based collaboration methodology to allow discussion and deliberation on the topic of interest within the community of interest, generating an argumentation tree based on the discussion and deliberation, and iteratively refining the argumentation tree based on the discussion and deliberation within the community of interest until the argumentation tree describes a consensus decision related to the topic of interest.

In another aspect, a system for collaborative decision making related to a topic of interest for a group of users that define a community of interest is provided. The system includes a memory area for storing a plurality of inputs provided by individual members of the community of interest related to the topic of interest, and a processor. The processor is programmed to define space in said memory to store data relating to the topic of interest, provide for the selection of individuals within a community of interest by one or more users, the individuals to be involved in the collaborative decision regarding the topic of interest, utilize at least one computer-based collaboration methodology to allow real time discussion and deliberation on the topic of interest by the selected individuals, generate an argumentation tree based on the discussion and deliberation for presentation at a user interface associated with the community of interest, and iteratively refine the argumentation tree based on inputs received from at least one of external sources and the users that make up the community of interest such that the argumentation tree describes a consensus decision related to the topic of interest.

In still another aspect, a collaborative decision making method is provided. The method includes establishing a community of collaborators based upon a decision to be made, the collaborators interconnected through a computer network, receiving, at a computer associated with the computer network, inputs from a plurality of the collaborators, the inputs relating to the decision to be made, iteratively generating, with the computer associated with the computer network, an argumentation tree illustrating the inputs of the plurality of collaborators, placement of the inputs within the argumentation tree based on a ranking of the individual inputs determined by the computer, displaying iterations of the argumentation tree at user interfaces of the computer network associated with the community of collaborators, iteratively receiving, at a computer associated with the computer network, further inputs from a plurality of the collaborators indicating their further input, the further inputs based at least in part upon contents of the argumentation tree; and generating a collaborative decision for display at the user interfaces of the computer network, the decision based upon the iterative inputs of the community of collaborators.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a flow diagram of an aircraft production and service methodology.

FIG. 2 is a block diagram of an aircraft.

FIG. 3 is a diagram of a data processing system.

FIG. 4 is an architecture diagram for a collective reasoning framework.

FIG. 5 is a depiction of a user interface associated with the collaborative reasoning framework.

FIG. 6 is a continuation of the user interface of FIG. 5 illustrating that a user can start a new issue discussion.

FIG. 7 is an argumentation tree depicting the process of an image analyst exploiting imagery of an electronics testing facility that is under surveillance.

FIG. 8 is a continuation of the argumentation trees of FIG. 7 illustrating feedback in response to the post of imagery to an SME.

FIG. 9 is a continuation of the argumentation trees of FIGS. 7 and 8 illustrating collaboration between the image analyst and a SIGINT analyst.

FIG. 10 is an example of a topic home page 1100.

FIG. 11 is a depiction of a topic details page.

FIG. 12 illustrates a display showing argumentation tree detail within one defined pane.

FIG. 13 is an illustration of a map annotation page.

FIG. 14 is an illustration of a multiple data source access page.

### DETAILED DESCRIPTION

The described embodiments propose an approach for collaborative decision making, specifically, a collaborative software environment to assist deliberative group decision making as well as iterative intelligence gathering and analysis. The described methods include collective reasoning on complex collaborative decision making problems, for example, using one or more of input from individuals within a community of interest and external data sources. For example, embodiments include a consensus building engine that automatically evaluates alternative options based on customizable decision making models. The consensus building engine not only allows inputs from collaborators, but also can automatically populate information from external data sources, for example, websites, databases, and other sources of electronic data.

The collective reasoning framework provides an integrated, network-enabled environment to help a group of people collaboratively make decisions in time-critical situations or for long term strategic decision making. The collective reasoning framework allows a team of geographically distributed members to quickly form into groups of collaborators, effectively work together through a decision process, and achieve consensus on the decision they are trying to make; and at the same time, retain group knowledge and decision making rationales for reviewing and reusing in the future through the storage of the collaborative efforts within a memory that is accessible by one or more of the community of interest.

The collective reasoning framework includes the above mentioned consensus building engine that automatically evaluates alternative options based on evidence based reasoning methods as well as other weighting/iterative/reasoning/decision models. In contrast, existing solutions only provide ways for aggregating arguments from different users into a tree-like structure.

In at least one embodiment, rich Internet application (RIA) technology is used for collaborative visualization of an argumentation network. One downside of previous argumentation mapping tools is they cannot support large scale complex problem solving very well due to visualization limitations. In contrast, RIA technology enables complex data visualization and enables better visualization and easy manipulation of the argumentation map. The use of the RIA technology enables complex data visualization and enables better visualization and easy manipulation of the argumentation map. Again, previous argumentation mapping tools get more awkward to operate when the argumentation map gets bigger and thus are not suitable for complex decision making problems.

The collective reasoning framework allows collaborative inputs not only from human, but also from domain data sources by customization. Existing solutions only aggregate human inputs.

Further, the collective reasoning framework serves as a group knowledge retention tool and provides capabilities to record the analytical thinking processes for future similar situations. Finally, previous argumentation map based systems can only be used in deliberative decision making and target decision making that needs days or even months. In the collective reasoning framework, a capability is provided for the automatic generation and publishing of decision making web services based on pre-built templates/argumentation maps for prompt decisions. Existing solutions only support long term deliberation, and therefore are not suited for short frame decision making. The capability of publishing decision making web services enables quick responses in time critical operations.

The collective reasoning framework provides ways to save, standardize, and index argumentation maps for different issues as templates for the future. Therefore the collective reasoning framework provides a way for reusing analytical processes in the future. Existing solutions enable users to review previously built argumentation trees, for example, but do not provide easy ways for reuse of previous argumentation maps.

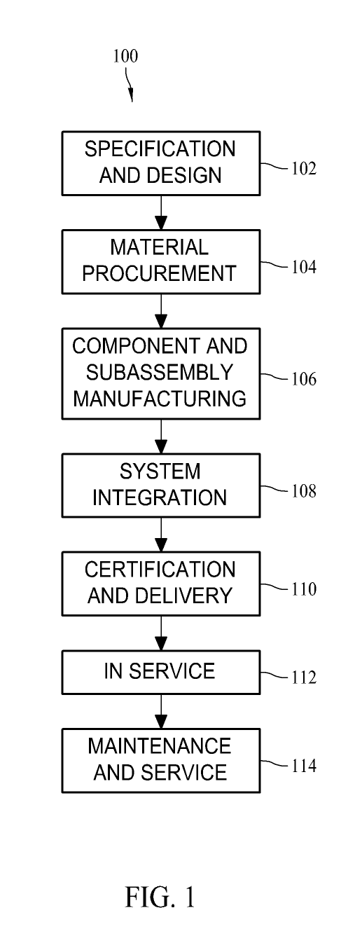

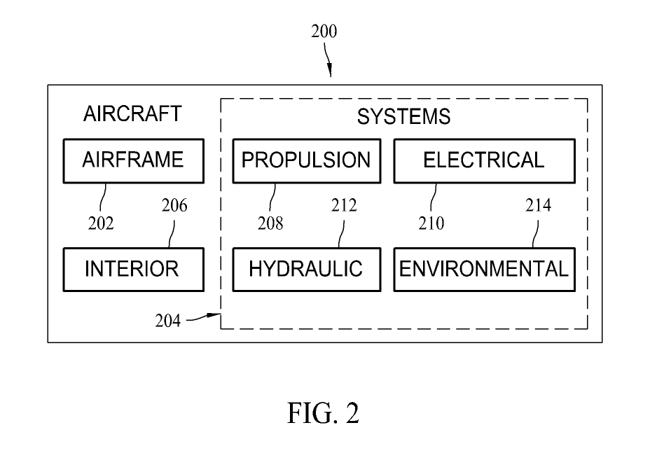

Referring more particularly to the drawings, embodiments of the disclosure may be described in the context of aircraft manufacturing and service method 100 as shown in FIG. 1 and an aircraft 200 as shown in FIG. 2. During pre-production, aircraft manufacturing and service method 100 may include specification and design 102 of aircraft 200 and material procurement 104.

During production, component and subassembly manufacturing 106 and system integration 108 of aircraft 200 takes place. Thereafter, aircraft 200 may go through certification and delivery 110 in order to be placed in service 112. While in service by a customer, aircraft 200 is scheduled for routine maintenance and service 114 (which may also include modification, reconfiguration, refurbishment, and so on).

Each of the processes of aircraft manufacturing and service method 100 may be performed or carried out by a system integrator, a third party, and/or an operator (e.g., a customer). For the purposes of this description, a system integrator may include, without limitation, any number of aircraft manufacturers and major-system subcontractors; a third party may include, for example, without limitation, any number of venders, subcontractors, and suppliers; and an operator may be an airline, leasing company, military entity, service organization, and so on.

As shown in FIG. 2, aircraft 200 produced by aircraft manufacturing and service method 100 may include airframe 202 with a plurality of systems 204 and interior 206. Examples of systems 204 include one or more of propulsion system 208, electrical system 210, hydraulic system 212, and environmental system 214. Any number of other systems may be included in this example. Although an aerospace example is shown, the principles of the disclosure may be applied to other industries, such as the automotive industry.

Apparatus and methods embodied herein may be employed during any one or more of the stages of aircraft manufacturing and service method 100. For example, without limitation, components or subassemblies corresponding to component and subassembly manufacturing 106 may be fabricated or manufactured in a manner similar to components or subassemblies produced while aircraft 200 is in service.

Also, one or more apparatus embodiments, method embodiments, or a combination thereof may be utilized during component and subassembly manufacturing 106 and system integration 108, for example, without limitation, by substantially expediting assembly of or reducing the cost of aircraft 200. Similarly, one or more of apparatus embodiments, method embodiments, or a combination thereof may be utilized while aircraft 200 is in service, for example, without limitation, to maintenance and service 114 may be used during system integration 108 and/or maintenance and service 114 to determine whether parts may be connected and/or mated to each other.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

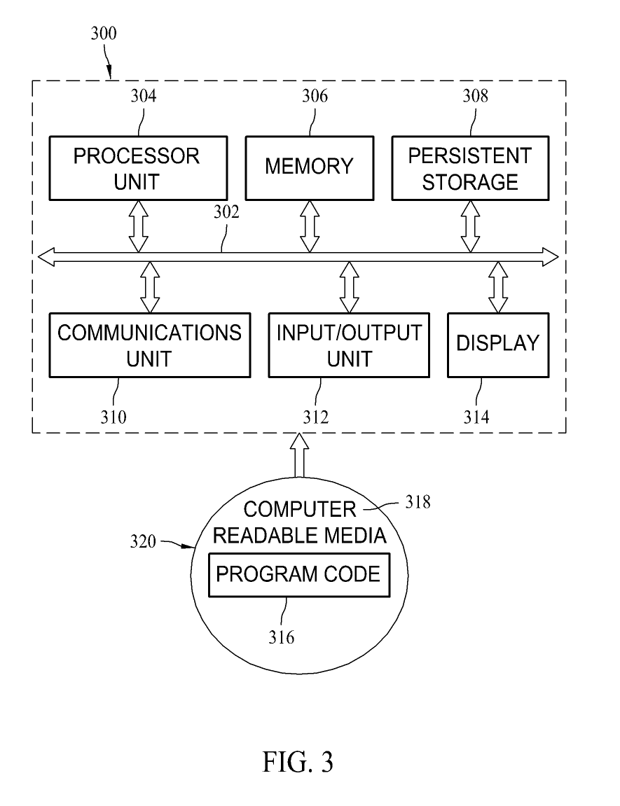

Turning now to FIG. 3, a diagram of a data processing system is depicted in accordance with an illustrative embodiment. In this illustrative example, data processing system 300 includes communications fabric 302, which provides communications between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 304 may be implemented using one or more heterogeneous processor systems in which a main processor is present with secondary processors on a single chip. As another illustrative example, processor unit 304 may be a symmetric multi-processor system containing multiple processors of the same type.

Memory 306 and persistent storage 308 are examples of storage devices. A storage device is any piece of hardware that is capable of storing information either on a temporary basis and/or a permanent basis. Memory 306, in these examples, may be, for example, without limitation, a random access memory or any other suitable volatile or non-volatile storage device. Persistent storage 308 may take various forms depending on the particular implementation. For example, without limitation, persistent storage 308 may contain one or more components or devices. For example, persistent storage 308 may be a hard drive, a flash memory, a rewritable optical disk, a rewritable magnetic tape, or some combination of the above. The media used by persistent storage 308 also may be removable. For example, without limitation, a removable hard drive may be used for persistent storage 308.

Communications unit 310, in these examples, provides for communications with other data processing systems or devices. In these examples, communications unit 310 is a network interface card. Communications unit 310 may provide communications through the use of either or both physical and wireless communication links.

Input/output unit 312 allows for input and output of data with other devices that may be connected to data processing system 300. For example, without limitation, input/output unit 312 may provide a connection for user input through a keyboard and mouse. Further, input/output unit 312 may send output to a printer. Display 314 provides a mechanism to display information to a user.

Instructions for the operating system and applications or programs are located on persistent storage 308. These instructions may be loaded into memory 306 for execution by processor unit 304. The processes of the different embodiments may be performed by processor unit 304 using computer implemented instructions, which may be located in a memory, such as memory 306. These instructions are referred to as program code, computer usable program code, or computer readable program code that may be read and executed by a processor in processor unit 304. The program code in the different embodiments may be embodied on different physical or tangible computer readable media, such as memory 306 or persistent storage 308.

Program code 316 is located in a functional form on computer readable media 318 that is selectively removable and may be loaded onto or transferred to data processing system 300 for execution by processor unit 304. Program code 316 and computer readable media 318 form computer program product 320 in these examples. In one example, computer readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer readable media 318 also may take the form of a persistent storage, such as a hard drive, a thumb drive, or a flash memory that is connected to data processing system 300. The tangible form of computer readable media 318 is also referred to as computer recordable storage media. In some instances, computer readable media 318 may not be removable.

Alternatively, program code 316 may be transferred to data processing system 300 from computer readable media 318 through a communications link to communications unit 310 and/or through a connection to input/output unit 312. The communications link and/or the connection may be physical or wireless in the illustrative examples. The computer readable media also may take the form of non-tangible media, such as communications links or wireless transmissions containing the program code.

In some illustrative embodiments, program code 316 may be downloaded over a network to persistent storage 308 from another device or data processing system for use within data processing system 300. For instance, program code stored in a computer readable storage medium in a server data processing system may be downloaded over a network from the server to data processing system 300. The data processing system providing program code 316 may be a server computer, a client computer, or some other device capable of storing and transmitting program code 316.

The different components illustrated for data processing system 300 are not meant to provide architectural limitations to the manner in which different embodiments may be implemented. The different illustrative embodiments may be implemented in a data processing system including components in addition to or in place of those illustrated for data processing system 300. Other components shown in FIG. 3 can be varied from the illustrative examples shown.

As one example, a storage device in data processing system 300 is any hardware apparatus that may store data. Memory 306, persistent storage 308 and computer readable media 318 are examples of storage devices in a tangible form.

In another example, a bus system may be used to implement communications fabric 302 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

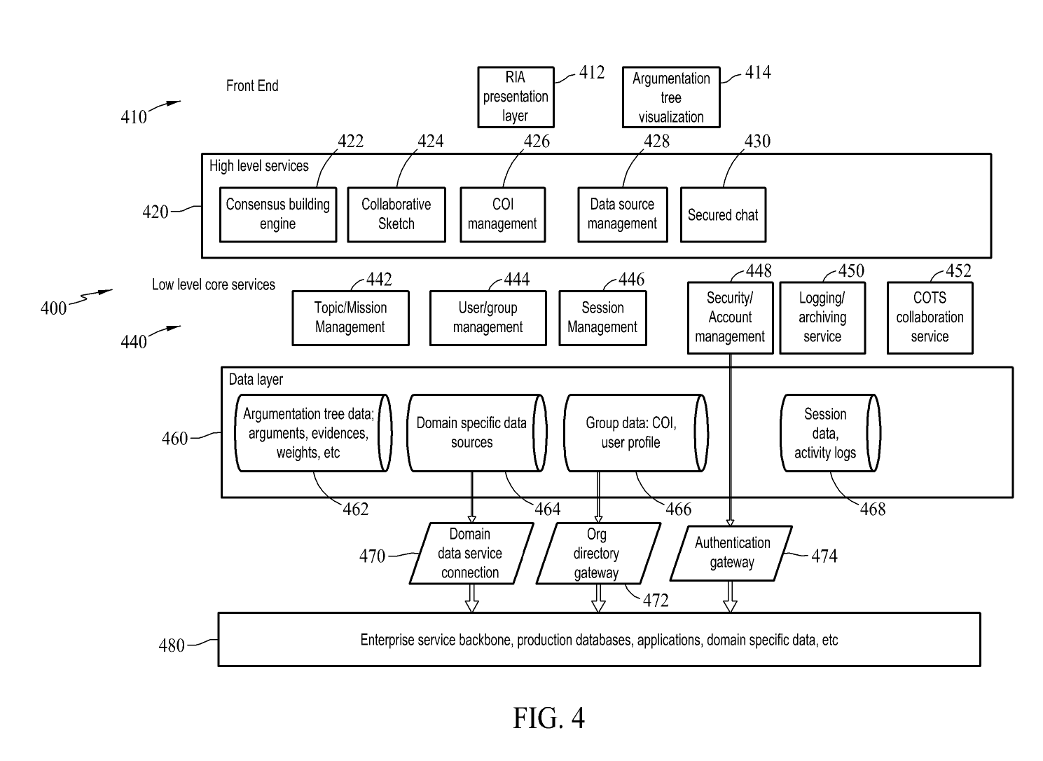

FIG. 4 is an architecture diagram 400 for a collective reasoning framework. A front end 410 includes a rich internet application (RIA) presentation layer 412 and argumentation tree visualization 414. High level services 420 include the afore mentioned consensus building engine 422, a collaborative sketching capability 424, community of interest (COI) management 426, data source management 428 and a secured chat capability 430.

Low level core services 440 includes topic/mission management 442, user/group management 444, session management 446, security/account management 448, a logging and archiving service 450, and a commercial, off the shelf (COTS) collaboration service 452.

A data layer 460 includes argumentation tree data 462 such as arguments, evidences, and weights, domain specific data sources 464, group data 466, including community of interest (COI) and user profile, and session data/activity logs 468. A domain data service connection 470 operates to couple domain specific data sources 464 to backbone 480. An organization directory gateway 472 operates to couple group data 466 to the backbone 480, and an authentication gateway 474 operates to couple security/account management 448 to the backbone 480. Backbone 480 includes an enterprise service backbone, production databases, applications, domain specific data and the like.

To provide a collaborative environment, the collective reasoning framework connects participants together with a set of tools, as shown in the architecture of FIG. 4, to encourage a collaborative environment for decision making. The providing of a collaborative environment includes managing communities of interest and the providing of new methods of interaction (e.g. chat, virtual worlds). A collaborative environment provides COI management, ad-hoc group formation and communication through chats, for example. Such an environment also provides a capability for remotely located human decision makers to undertake collaborative whiteboarding and sketching.

For group decision and planning support, the collective reasoning framework provides a set of decision making tools. In addition to traditional decision making models such as multi-criteria decision making models, the collective reasoning framework also provides a consensus building engine along with some analysis and visualization tools.

Group decision and planning utilizes the consensus building engine to allow group members to take different positions and select various preferences, to go through a process of dissolution of conflicts and discovery of new information, and to reach a common agreement on some solution. A group decision toolset that has several decision making models is thus integrated.

The collective reasoning framework allows for easy integration of multiple decision aid methods, and selects between these methods, on the fly, to support the goals of the participants. One goal of the collective reasoning framework is to be flexible and allow integration of a wide variety of potential decision aids, including optimizations, information retrieval, fusing, and collaboration with an expert, among others.

The collaborative environment provides COI management: through ad-hoc group formation and communication through, foe example, chats while also providing a capability for un-collocated human decision makers for collaborative whiteboarding and sketching. Group decision and planning is supported through the consensus building engine to allow group members to take different positions and various preferences, to go through a process of dissolution of conflicts and discovery of new information, and to reach a common agreement on some solution. As a result, a group decision toolset is integrated that includes several decision making models

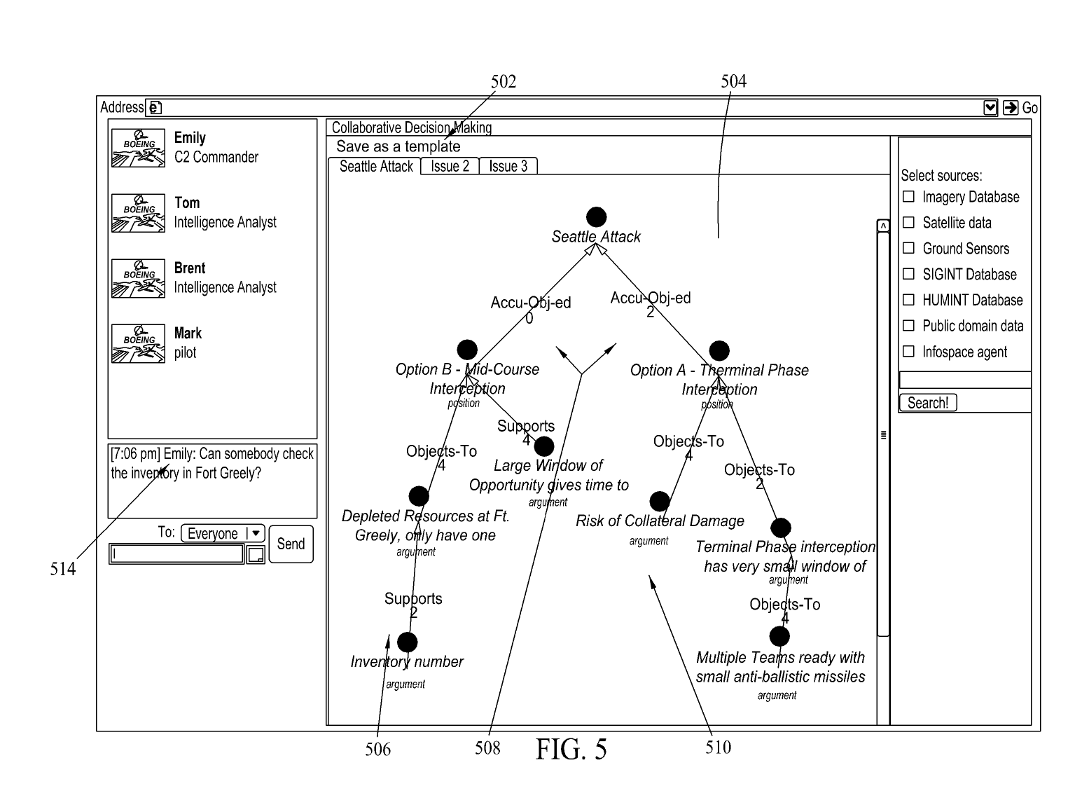

FIG. 5 is a depiction of a user interface 500 associated with the collaborative reasoning framework. One option 502 on the user interface 500 allows the user to save the displayed argumentation tree 504 as a template for automatic/semi-automatic generation of decision results in similar situations in the future. Within the argumentation tree 504, certain data items/facts, for example inventory number 506 are automatically populated from various data sources. Options 508 are automatically evaluated by an inference engine and users can collaboratively input options and/or evidences 510. Subwindow 514 illustrates the herein described secured chat capability.

In one embodiment, open source RaVis is utilized for visualization of argumentation trees. The action script-based library within RaVis enables users to create complex data visualization interfaces for the analysis of relational data sets such as social networks, organization trees, navigation systems, taxonomies, database schemas, and other link-based phenomena. The library is purposely extendable and provides for separation of base, interface, and layout code. Additional layout algorithms can be readily integrated as an extended class containing only the mathematical calculations and controls needed specifically for the layout.

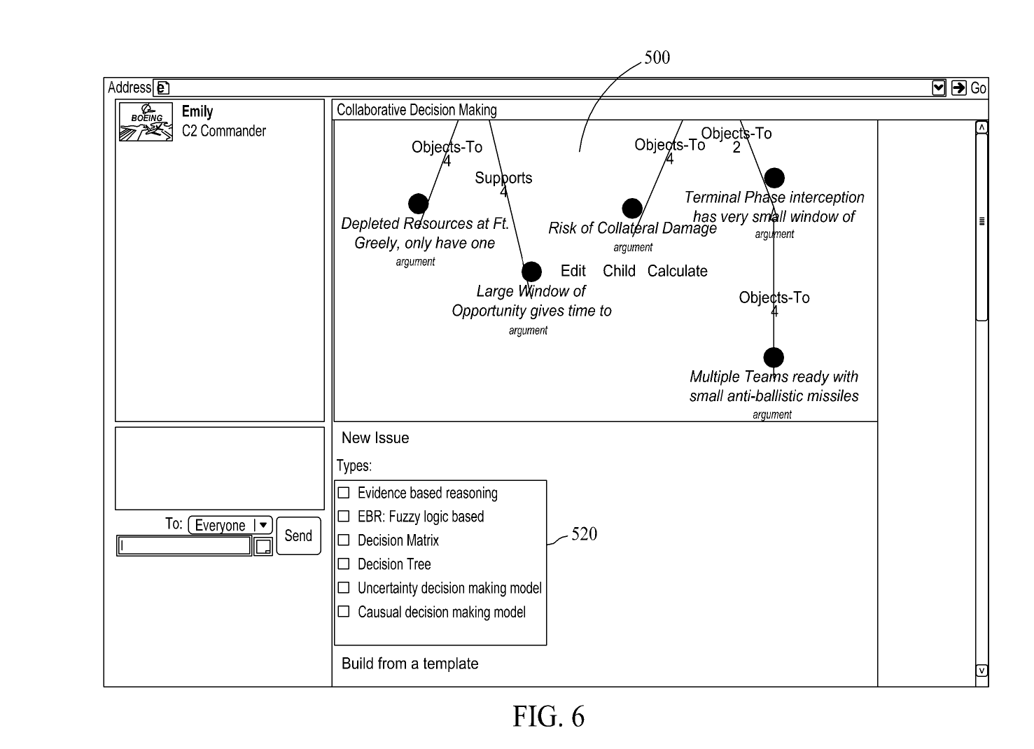

FIG. 6 is a continuation of the user interface of FIG. 5 illustrating that a user can click on “New Issue” 520 to start a new issue discussion, and the default decision making type is evidence based reasoning. However, the user who starts the issue discussion can select other types of decision making model, including evidence based reasoning, fuzzy logic evidence based reasoning, decision matrix, decision tree, an uncertainty decision making model, and a causal decision making model.

The collective reasoning framework leverages the concept of argument maps and makes them collaborative, such that a group of people can together build argumentation trees, such as shown in FIGS. 5 and 6, that represent the options they see to address a topic, and use these argument maps to make a decision. The argument map structure also serves as a historical record of the thought processes that led to a decision, and may be referred to in the future to analyze the decision process and look for improvements in future decision processes.

In summary, the collective reasoning framework provides the following advantages:

Collaborative decision making: disperse group of people can debates the options they have to respond to different situations using argumentation trees, secured chats, collaborative sketch, etc.

Group knowledge retention: as the collaborators work together, they put down their opinions/options they have and the tradeoffs between them so that the group can start moving towards deciding on which one to take. Such decision making rationale is critical for group knowledge retention. In the collective reasoning framework, the decision map can be saved and published as templates. Templates can be standardized to be used in the future and by other people within an organization.

Flexibility: a user can create customized decision making templates for a particular situation in from several minutes to an hour, overcoming the shortcoming of stovepipe applications and providing an extremely flexible decision making environment.

Human to system collaboration: better integrate human inputs into the decision making model.

General framework: The collective reasoning framework provides a general framework for the integration of different decision making models and different information fusion models.

Central to the operation of the collective reasoning framework, is the envisioning of how the group of collaborators work together to come to a decision. Though there are endless varieties of decisions that groups may need to make, there are workflow commonalities that lay the foundation for a general software-aided decision process. The collective reasoning framework assists the following steps in collaborative decision making: topic definition, team formation, idea/option creation, option assessment and user opinions, options ranking, group consensus and final decision and execution.

In regard to topic definition and workspaces, the collective reasoning framework operates as a dynamic space for multiple groups of users to work together, so the global set of users can collaborate on multiple topics at any given time. The initial stage of the decision process is recognizing that a topic of interest exists and defining a space in the collective reasoning framework to store persistent data pertinent to the topic. Triggers initiate the creation of a topic workspace. One type is user-initiated, such that any user can start a new topic to collaborate on and then become a manager of the new topic workspace. Other triggers could be automated, such that when certain events occur or information is received, the system intelligently generates a topic of interest and allocates the workspace resources needed for collaboration. The collective reasoning framework's integration of numerous external data sources provides many triggers to react to and intelligently determine areas of concern that should be addressed with a collaborative workspace.

Once a topic has been identified, the next step is to define and manage a community of interest around it with individuals who need to be involved in the decision process, which is referred to herein as team formation. Users might be invited to a topic by its creator, assigned to a topic by a superior, or simply browse a public topic and join on their own initiative. In the automated case, teams are intelligently formed by the system using the stored profiles of users to assess their interests and areas of expertise and form a team in response to event triggers. Even after a workspace has been established and functioning, changes in the environment could require another user expert to come in and provide input. Collaborators can come and go throughout the lifecycle of the decision topic, but the input they provide persists in the workspace defined for the topic.

In regard to idea/option creation, once the appropriate team has been defined and brought together, they can work together in various ways to explore the problem space of their topic. Numerous collaboration methodologies can be used (e.g., chat, video, voice, white boarding) to allow group discussions and deliberation. As the group works together, new ideas and insights will be made and should have mechanisms to be recorded in the workspace. Certain users may have expertise in an area and provide inputs to cover those areas, and together with the whole group they are able to model enough of the decision space to make an informed decision. Automated options generation tools intelligently feed the workspace with suggested courses of action (multi-criteria optimization, etc). These tools look and act like user-submitted data, but could automatically be added in response to triggers to which the system is capable of responding.

Managing the ideas being created is also an important aspect of the workspace. As ideas are created and discussed, their evolution is documented and easily understood by the collaborators. An interesting mechanism for managing the knowledge lies in argumentation nets, which are visual representations of logic flow that allow the critical thinking process to be documented in an intuitive manner.

Argument maps provide the following benefits to complex decision making scenarios: provides structure to complex ideas in graphical form, allows for effective analysis and evaluation of arguments, provides a fast overview of the overall state of an argument/discussion, filters out unnecessary or redundant ideas and focuses on the main points of discussion, and provide an effective basis to assess logic, answer questions, and make a decision.

The collective reasoning framework leverages the concept of argument maps and makes them collaborative, such that a group of people can together build argument maps that represent the options they see to address a topic, and use these to make a decision. The argument map structure also serves as a historical record of the thought processes that led to a decision, and referred back to in the future to analyze the decision process and look for improvements in the future.

For option assessment and user opinions, an important part of the decision process is idea refinement, and the collaborative environment is crucial to idea refinement. Over time, the group iteratively models the situation and the decision space. Users are able to view the ideas generated by others, make additions to them, comment on them, and help push the decision process closer to consensus. The group iteratively refines their model of the problem space and the options they have to decide between, and the workspace stores the evolving model and the path the group took to get there.

While the argument map is being built, the options with the most merit, support from the user base, and likelihood to succeed are noted. The collective reasoning framework handles this by determining an estimated ranking for each of the options the team is considering. Many different methods for ranking could exist, leveraging both user-determined rank (thumbs up/down, numerical) or partially automated (‘most active’ ideas, link analysis, logic analysis, etc). A standardized ranking algorithm that takes into account both automated and user-driven inputs will drive the workspace to achieve consensus quickly since the visualization can focus on the options with the highest potential.

Users can increase the rank of an option with the inputs that they provide. They can explicitly define their statements to ‘support’ or ‘oppose’ the option they are adding information to, which will then be rendered visually in the argument map with colors and text designation. Optionally, a user can provide a weighting to their input, such that the ranking algorithm can better determine which inputs should hold more importance than others. An example set of input categories could be: Strongly oppose, oppose, neutral, support, and strongly support. Maps with larger numbers of total ‘support’ nodes will tend to be ranked higher. Additionally, collaborators can further increase or decrease their support for a node given by another person via a ‘thumbs up’ or ‘thumbs down’ mechanism.

In addition to the manual input of support and opposition data by the user, the collective reasoning framework system can infer rank based on a number of criteria. The system keeps track of which options have the most activity in terms of map views, edits, and number of inputs, to name a few. This rank provides some insight as to which concepts are most interesting to the collaborators and perhaps deserve more attention. More advanced inference mechanisms could potentially make logic inferences based upon the information placed in the map.

Group consensus is achieved when the group can agree upon a course of action from the ones they have discussed. The final model of the decision space allows the group to cleanly view all ranked options, the logic behind them, and allow them to make an effective decision as a group. The topic workspace serves as a record of the thought process the group went through and the information driving the conclusions to which they came.

With the group achieving consensus, they can move forward to execute the final decision. The purpose of the collaborative decision topic is achieved and the topic workspace can be archived for future reference. This collaborative decision making workflow suits decision making process that takes at least several hours. For quick decision making, there will not be enough time to do group deliberation. For short-frame decision making, independent web services are dispatched from the group generated, pre-defined decision making templates for particular situations/use cases. These web services automatically pull in data to fill the templates for the current situation and generate instant decisions for these situations with very little user interactions.

Metrics: Part of the effort in defining a collaborative environment is proving that it provides a positive impact to the decision making abilities of distributed teams. Some metrics that could be useful to track are: information availability and quality (number of linked external information sources, number of participants), participation (number of collaborative sessions (chat, voice, whiteboard, etc.), number of argument maps, size of argument maps), efficiency (time to consensus, cost savings of enabling distributed teams), and decision making (mission effectiveness (achieved original goals) and decision quality (was selected option the best one).

Evidence based, context influenced reasoning:

In embodiments, approaches have been constructed two approaches for collaborative reasoning about decisions. In one embodiment, a simple weighted evidences inference is utilized that follows the rules below.

(1) Different users are assigned different priority. As such, evidences proposed by people with higher priority have higher confidence value. (2) If evidence B supports position A, and evidence C supports evidence B, then evidence C supports position A. (3) If evidence B supports position A, and evidence C objects to evidence B, then evidence C objects to position A. (4) If evidence B objects to position A, and evidence C supports evidence B, then evidence C objects to position A. (5) If evidence B objects to position A, and evidence C objects to evidence B, then evidence C supports to position A.

However, actual (e.g., real life) reasoning is typically not linear. As such certain of the above described embodiments incorporate a collaborative fuzzy inference engine for more precise modeling and assistance of the human reasoning process.

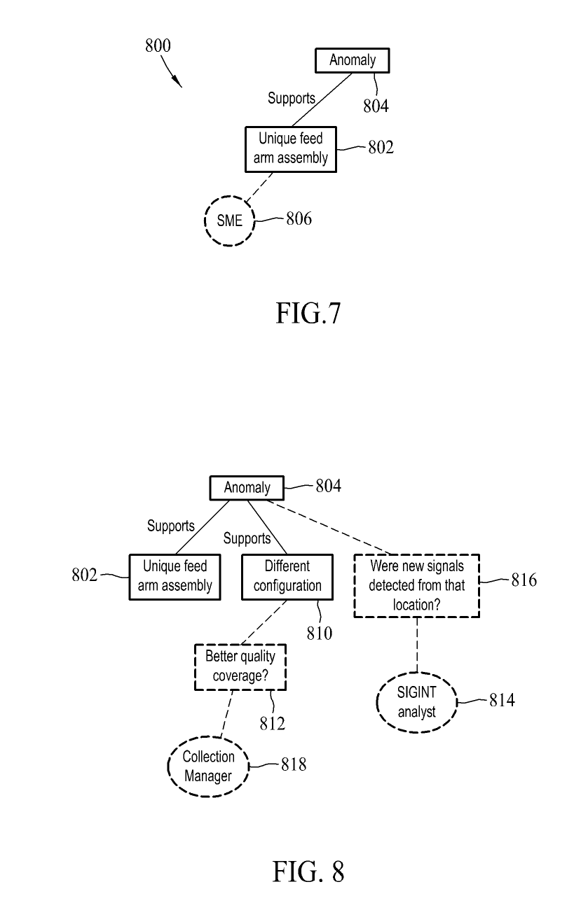

One scenario is depicted by FIGS. 7-9, which constitutes an image analyst scenario, where there is more focus on the dynamics of seeking evidence and experts.

FIG. 7 is an argumentation tree 800 of an image analyst that is exploiting imagery of an electronics testing facility. The analyst observes a known radar type and believes she has spotted a unique feed arm assembly 802 supporting an initial conclusion that an anomaly 804 has been uncovered, as the feed arm assembly is not thought to be part of a known variant. The image analyst then uses a “SME-finder” 806 to locate an expert on that country's electronics capabilities.

Moving on to FIG. 8, the image analyst then posts imagery of the feed arm assembly so the SME can provide some feedback. The SME agrees that it is a different configuration 810, but to support such conclusion suggests that better quality coverage 812 is needed as well as coordination with SIGINT analysts 814 to see if any new signals were detected 816 from that facility.

The image analyst next collaborates with collection manager 818 to identify potential for high-NIIRS coverage at specific geometry and time of day to: look for high quality, determine geometric constraints to get good look aspect on feed arm, and note that earlier satellite passes are preferable to get good shadows with respect to the assembly. The collection manager performs feasibility access prediction, posts possible satellite accesses in next three days, and reviews with the image analyst to get recommended access for emphasis.

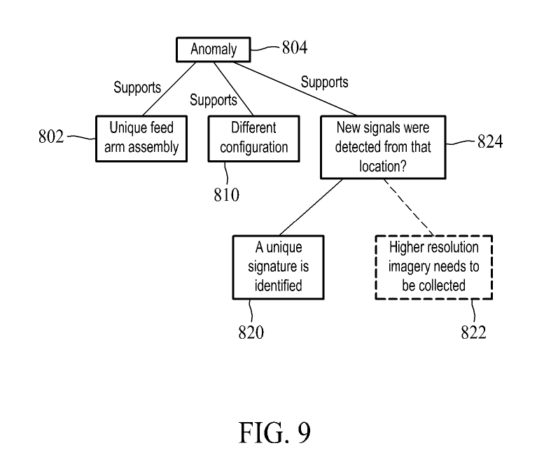

Moving on to FIG. 9, the image analyst collaborates with SIGINT analyst who reviews recent reporting in region and identifies a unique signature 820 and enters the site and signal type into tasking system for further collection. Once higher resolution imagery is collected 822 a collaborative determination that new signals from the region have been detected 824.

The herein described collaborative framework helps this scenario by inviting members of a community of interest, allowing the SME to input his observations and get more personnel involved, such as a SIGINT analysts who then inputs his arguments. Sources of arguments in this scenario include the image analyst, the SME, and the SIGINT analyst. The scenario shows how the collaborative framework can help the intelligence workflow by dynamically inviting relevant participants to the COI and collaborative data seeking to support the decision making processes.

People from different locations, with assistance of the collaborative environment, are able to clearly understand each others' arguments without iteratively questioning. Secured chat tools and sketch/whiteboarding tools integrated within the framework above described enables them to discuss issues without physically walking to each other's location.

In the scenario, most of the people are working together using the collaborative framework tool already so they do not need to bring each other into the argumentation process. Dotted lines are used to show people who are sent invitations to the community of interest (COI) (or new evidence that need to be provided).

As the above described scenarios indicate, there are users. Each user is a member of a single organization, and has a set of expertise(s). In one embodiment, there is a single ranking of overall expertise level, on a scale of one to five. For example, a user can be logged in to the overall Collaborative Analysis Environment, and their presence is indicated to other users. In embodiments, users can be away, in meetings, etc. but they are still listed as present.

There are also topics. These are the topics of analysis, and each topic is made up of issues (and each issue has its own argumentation tree supporting it). A topic also has a team associated with it. Teams are made up of users.

The primary real-time collaboration is text chat. Text chat is on per-page basis, and each page is essentially another “room” of chat. Chat is persistent, leaving a page and coming back wipes out the chat history displayed in the chat widget, but the history is available through a different screen.

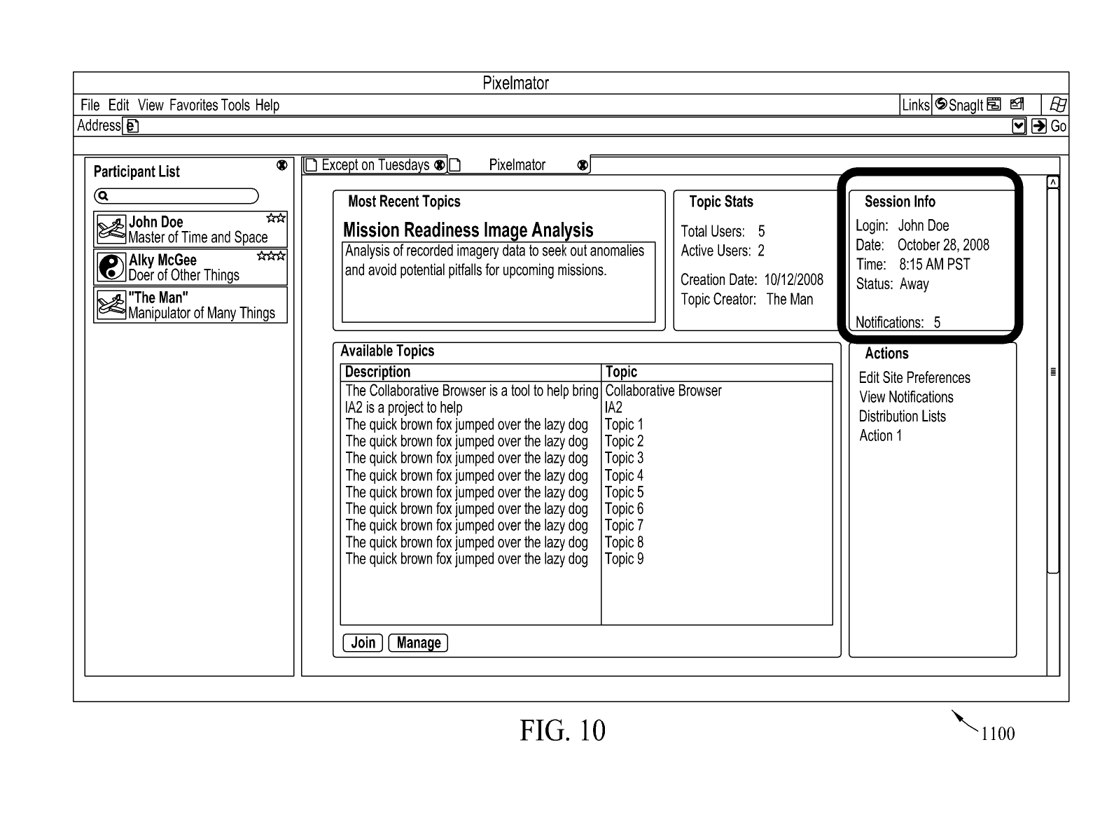

In an embodiment of a login page, a username and password are used, while logins and current sign-in status are logged to the database to maintain presence information. Once a login is successfully completed, the user is taken to a topic home page 1100, an example of which is shown in FIG. 10. The topic home page includes a currently logged-in user pane, which includes, for each user: name, title, organization, expertise, expertise rating (for example one to five stars), an online status, and a current topic COI. The fields are retrieved from the database.

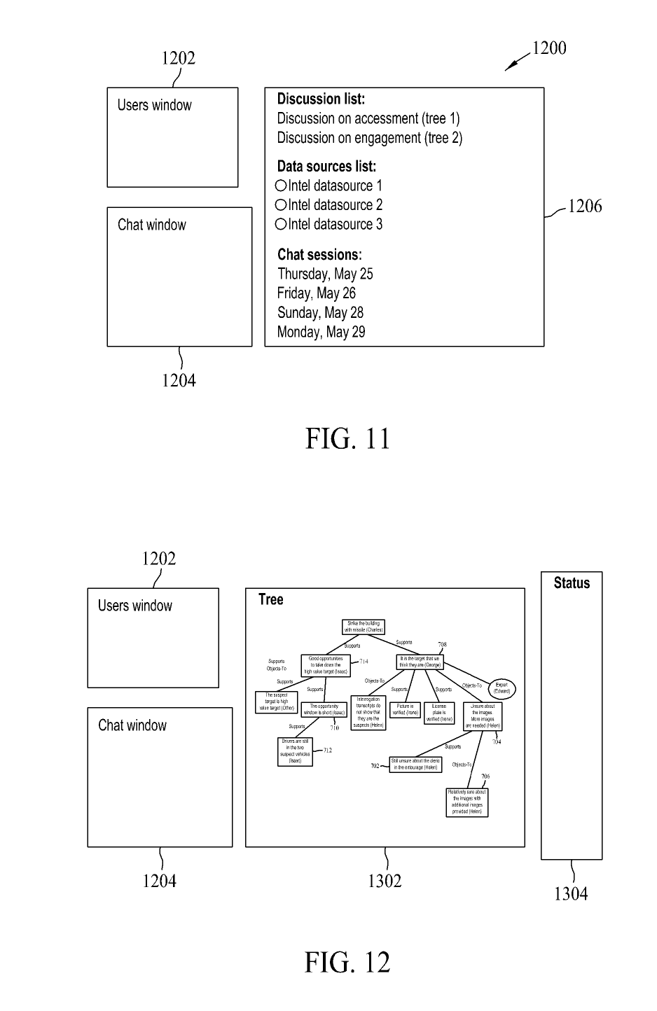

When the user first enters, the user pane shows all logged-in users. On the topic screens the user pane shows only users for that topic. A topic panel includes fields for topic name, topic description, last modified, total number of people providing entries, creator/owner name. All fields are dynamically pulled from the database, and clicking on a topic name causes a topics details page to be displayed (which is shown in FIG. 11).

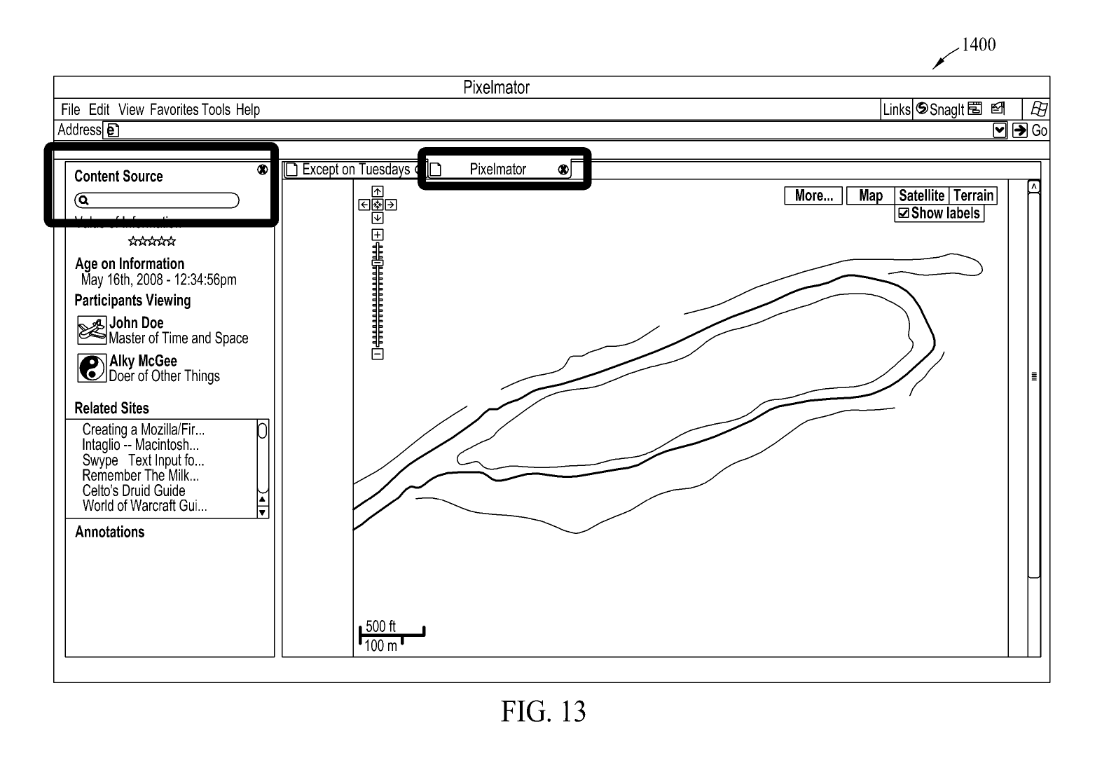

In a most recent update panel, information about the most recently updated topic is displayed. The fields include: topic name, topic description, last modified time, last update, last update action. Selecting a topic name causes a topics details page to be displayed (which is shown in FIG. 12).

FIG. 11 is a depiction of a topic details page 1200 which includes a user status pane 1202, a chat pane 1204, and a topic information display 1206. The user status pane 1202 is the same as the currently logged-in user pane of the topic home page 1100, and is filtered by people in the current COI. In regard to the chat pane 1204, once a user enters a COI, there is a single public chat room that is displayed in the chat pane 1204. Every member of the COI can send (and read) messages in the chat room, as displayed on the chat pane. In the chat room, there is also the ability to send a private message to an individual.

All messages are stored on a server, and the most recent N messages are displayed when the user joins the COI, to provide context. This includes the appropriate private messages (to/from the user logging in). The chat transcripts are available as a page and are shown, for example, in topic information display 1206 and on a day-by-day basis. These are limited to people in the current COI, and the user is able to send private messages to other people currently present.

In the topic information display 1206, a “Discussion List,” a “Data Sources List”, and “Chat Sessions” are shown. Selection of a discussion list causes an argument tree detail (shown in FIG. 12) to be shown. There are multiple issues per topic and an issue is a root of an argumentation tree. Topics need a list of issues that belong to the topic, or some sort of linkage between the topics and the issue nodes, a user is further allowed to create a new topic

Selection of data sources entries will select the data sources, for example, a web search based on a key word search. Results from these data sources are then shown.

Group chat sessions are also shown in display 1200.

FIG. 12 illustrates a display 1300 showing argument tree detail and includes the user pane of FIG. 11, showing only the people currently in the COI, the chat pane 1204 of FIG. 11 for users currently in this COI, a tree pane 1302, and an update (status) pane 1304. The update pane 1304 illustrates textual updates to the tree, such as “John just added evidence to the tree under ‘Entourage does not include Cleric’”. The textual updates are those updates that have occurred since the user loaded the page.

FIG. 13 is an illustration of a map annotation page 1400 and includes a user pane and a chat pane as the pages described above as well as image meta-data and a tagging history.

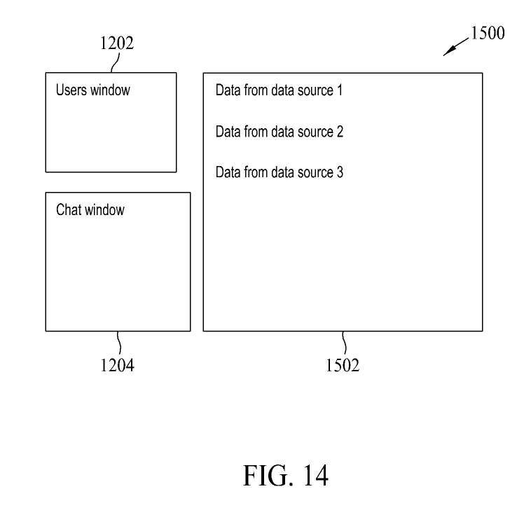

FIG. 14 is an illustration of a multiple data source access page 1500 which includes the user pane 1202 and the chat pane 1204 of FIG. 11 as well as a data source pane 1502 where, in the embodiment illustrated, three intelligence applications (e.g., data sources) are shown. In the collaborative environment, when the data source is selected, it automatically retrieves the relevant data, for example, by logging in to different database and retrieving data.

In summary, the described embodiments propose improved methods for complex collaborative decision making by enabling machine assisted evaluation of evidences, incorporating inputs from both human users and domain data sources, enabling group knowledge retention, utilizing novel effective collaborative visualization approach, and allowing both deliberative (long timeframe) and reactive (short timeframe) collaborative decision making. The embodiments include a software description, component design, software flow, and a GUI configuration.

Various airline companies, aircraft manufacture companies, aircraft material supplier companies can benefit from using this tool to facilitate effective collaboration in work processes and improvement of work efficiency. The embodiments relate to a collaboration tool that can be utilized in many different domains and scenarios, thus significant costs will be saved on developing different collaboration software for various domains and tasks.

The collective reasoning framework can be widely used in various kinds of business and engineering tasks and will improve collaboration in workplace environments thereby improving productivity. The collective reasoning framework also serves as a group knowledge retention tool to capture and reuse group knowledge, and therefore, the collective reasoning framework reduces the cost of training, leaning, and knowledge recreation due to lack of sharing. As a result, customers and suppliers can both benefit from the collaborative environment by utilizing the collective reasoning framework to facilitate collaboration and improve work efficiency in their business.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for building a framework to be utilized in collaborative decision making related to a topic of interest, said method comprising:
defining a space within a memory to store data relating to the topic of interest;
selecting individuals within a community of interest to be involved in the collaborative decision regarding the topic of interest;
using at least one computer-based collaboration methodology to allow real time discussion and deliberation on the topic of interest within the community of interest;
generating an argumentation tree based on the discussion and deliberation; and
iteratively refining the argumentation tree based on the discussion and deliberation within the community of interest until the argumentation tree describes a consensus decision related to the topic of interest.

2. A computer-based method according to claim 1 further comprising at least one of:
initiating, by a user, a topic of interest for collaboration within a community of interest; and
automatically initiating a topic of interest for collaboration within a community of interest based on an event occurrence or received information from an external data source.

3. A computer-based method according to claim 1 wherein selecting individuals within a community of interest comprises at least one of:
inviting, by a creator of the topic of interest, a user to join the community of interest;
assigning, by a superior, a user to the community of interest;
browsing a public topic of interest by a user and joining the community of interest of their own initiative; and
forming a community of interest using stored profiles of users based on the topic of interest and expertise of the users.

4. A computer-based method according to claim 1 wherein using at least one computer-based collaboration methodology comprises using at least one of chat, voice, video, and whiteboarding. to allow group discussions and deliberation.

5. A computer-based method according to claim 1 wherein generating an argumentation tree comprises feeding the framework space with suggested courses of action in response to received data from an external data source.

6. A computer-based method according to claim 1 wherein generating an argumentation tree comprises automatically populating the argumentation tree with information from domain data sources.

7. A computer-based method according to claim 1 wherein iteratively refining the argumentation tree based on the discussion and deliberation within the community of interest comprises one or more of viewing the ideas generated by others, making additions to the ideas generated by others, and commenting on the ideas generated by others to push the decision process closer to consensus.

8. A computer-based method according to claim 1 further comprising using rich internet application technology to visualize the argumentation tree.

9. A computer-based method according to claim 1 further comprising storing the argumentation tree to record the collaboration process for future topics of interest similar to the topic of interest.

10. A computer-based method according to claim 1 generating an argumentation tree comprises utilizing a pre-built argumentation map.

11. A system for collaborative decision making related to a topic of interest for a group of users that define a community of interest, said system comprising:
a memory area for storing a plurality of inputs provided by individual members of the community of interest related to the topic of interest; and
a processor programmed to:
define space in said memory to store data relating to the topic of interest;
provide for the selection of individuals within a community of interest by one or more users, the individuals to be involved in the collaborative decision regarding the topic of interest;
utilize at least one computer-based collaboration methodology to allow real time discussion and deliberation on the topic of interest by the selected individuals;
generate an argumentation tree based on the discussion and deliberation for presentation at a user interface associates with the community of interest; and
iteratively refine the argumentation tree based on inputs received from at least one of external sources and the users that make up the community of interest such that the argumentation tree describes a consensus decision related to the topic of interest.

12. A system according to claim 11 wherein said processor is further programmed to:
initiate, through user input, a topic of interest for collaboration within a community of interest; and
automatically initiate a topic of interest for collaboration within a community of interest based on an event occurrence or received information from an external data source.

13. A system according to claim 11 wherein to provide for the selection of individuals within a community of interest, said processor is programmed to:
invite, based on input by a creator of the topic of interest, a user to join the community of interest;
assign, based on input by a superior, a user to the community of interest;
allow a user to join the community of interest of their own initiative, based on a level of access granted to the user; and
automatically form a community of interest using stored profiles of users based on the topic of interest and expertise of the users.

14. A system according to claim 11 wherein to utilize at least one computer-based collaboration methodology, said system is programmed to implement at least one of interactive chat, voice, video, and whiteboard displays to the users that make up the community of interest.

15. A system according to claim 11 wherein to generate an argumentation tree, said processor is programmed to suggest courses of action to the community of interest in response to received data from an external data source.

16. A system according to claim 11 wherein to generate an argumentation tree, said processor is programmed to automatically populate the argumentation tree with information from data sources outside of the users of said system.

17. A system according to claim 11 wherein said system is programmed using rich internet application technology to generate the argumentation trees.

18. A system according to claim 11 wherein said processor is programmed to store a generated argumentation tree such that the collaboration process for future topics of interest similar to the topic of interest can be retrieved.

19. A system according to claim 11 wherein said memory comprises a pre-built argumentation map.

20. A collaborative decision making method comprising:
establishing a community of collaborators based upon a decision to be made, the collaborators interconnected through a computer network;
receiving, at a computer associated with the computer network, inputs from a plurality of the collaborators, the inputs relating to the decision to be made;
iteratively generating, with the computer associated with the computer network, an argumentation tree illustrating the inputs of the plurality of collaborators, placement of the inputs within the argumentation tree based on a ranking of the individual inputs determined by the computer;
displaying iterations of the argumentation tree at user interfaces of the computer network associated with the community of collaborators;
iteratively receiving, at a computer associated with the computer network, further inputs from a plurality of the collaborators indicating their further input, the further inputs based at least in part upon contents of the argumentation tree; and
generating a collaborative decision for display at the user interfaces of the computer network, the decision based upon the iterative inputs of the community of collaborators.
